(19) United States
(12) Patent Application Publication
(10) Pub. No.: US 2022/0089221 A1
(43) Pub. Date: Mar. 24, 2022

(54) DETERMINING A STEERING REFERENCE STATE BY MEANS OF WHEEL SPEED VALUES

(71) Applicant: Volkswagen Aktiengesellschaft, Wolfsburg (DE)

(72) Inventors: Björn Makkus, Braunschweig (DE); Henrik Liesner, Braunschweig (DE)

(21) Appl. No.: 17/477,418

(22) Filed: Sep. 16, 2021

(30) Foreign Application Priority Data
Sep. 21, 2020 (DE) 102020211769.1

(51) Int. Cl. B62D 15/02

(52) U.S. Cl. CPC B62D 15/0245; B62D 15/0225

(57) ABSTRACT

A control unit and a method for determining a steering reference state for a vehicle. A first wheel speed value that is a wheel speed value for a wheel on the vehicle is obtained. At least one second wheel speed value that is a wheel speed value for another wheel on the vehicle is obtained. Using the first and second wheel speed value, a steering reference state is determined, corresponding to travel in a straight line by the vehicle.

### CROSS REFERENCE TO RELATED APPLICATION

The present application claims priority to German Patent Application No. DE 10 2020 211 769.1, to Makkus, et al., filed Sep. 21, 2020, the contents of which is incorporated by reference in its entirety herein.

### FIELD OF TECHNOLOGY

The present disclosure relates to a control unit and techniques for determining a steering reference state, wherein the steering reference state corresponds to travel in a straight line. The present disclosure relates in particular to the automobile industry and also in particular to the motor vehicles such as, e.g., passenger automobiles and trucks. Accordingly, the steering reference state (or guidance reference state) can relate to a reference state for a steering system and/or steering gear in a vehicle.

### BACKGROUND

For vehicle steering systems, the precise determination of certain steering reference states is of particular relevance. One example of such a steering reference state is travel in a straight line. In this state, a steering angle corresponds to a steering gear at 0°, where the wheels are turned neither to the right nor to the left. By way of example, the precise determination of the reference state is relevant for obtaining knowledge regarding how a current deflection of the steering system actually results in a steering angle deviating from travel in a straight line. More precisely, the determination of this reference state offers the possibility of determining an angular difference or relative deflection from this reference state as the actual steering angle that has been set.

A steering reference state corresponding to travel in a straight line can also be referred to as a “zero setting” of the steering system. The reason to determine this zero setting (or neutral position) is that steering systems usually cannot be precisely and symmetrically installed such that a target zero setting can be obtained precisely. Instead, an actual zero setting is usually slightly off from the target zero setting to a certain degree due to component and installation tolerances. This angular deviation can also be referred to as an offset angle. It quantifies the difference between the actual zero setting from the target zero setting for an ideal, and in particular an ideally symmetrical, steering system.

The determination of the zero setting for a steering system on the basis of a determined yaw rate is known. EP 2 243 686 B1 discloses a means of doing so in which thermal effects on a yaw rate sensor are compensated for. If a yaw rate of substantially zero is determined, it can be assumed that the reference state refers to travel in a straight line, and the present steering angle (e.g., detected by sensors) can then be determined.

EP 2 627 550 B1 and US 2017/0210185 A1 contain further technological background information.

The above solutions have proven to be insufficiently precise in determining the desired steering reference state.

### SUMMARY

An aspect of the present disclosure is therefore to obtain an alternative means of determining when a vehicle is traveling in a straight line that is distinguished in particular by a high level of precision with limited complexity in terms of measurement technology.

These aspects are achieved by the subject matter of the independent claims. Advantageous developments are defined in the dependent claims. All of the above explanations and definitions may also relate to the present disclosure, as long as not otherwise indicated or apparent.

The present disclosure proposes a comparison of vehicle wheel speeds in general, in order to detect travel in a straight line. If this travel in a straight line is detected, it is then possible to proceed in principle in accordance with all of the known approaches from the prior art. The present disclosure proposes in particular the definition of a steering angle determined in a steering angle measurement system in the vehicle as the zero setting and/or storing the difference between this angle and a previously assumed angle for the zero setting as an angular offset value. The zero setting (or angular offset value) determined in this manner can be used, for example, to determine an actual current or set steering angle in relation to this zero setting.

In particular, the present disclosure proposes a method for determining a steering reference state for a vehicle (e.g., a motor vehicle, and in particular a passenger automobile or truck), comprising:
obtaining a first wheel speed value that is a wheel speed value for one wheel on the vehicle;
obtaining a second wheel speed value that is a wheel speed value for at least one other wheel on the vehicle;
determining whether a steering reference state exists that corresponds to travel in a straight line on the basis of the first and second wheel speed values.

The two wheels can both be on the same vehicle axle, in particular a vehicle axle that can be steered. This is preferably the front axle in the vehicle. In particular, these can be the wheels on the inside and outside of a curve, or the wheels that form the wheels on the inside and outside of a curve when traveling through a curve.

The wheel speed values can specifically be the rotational rates of the wheels. In general, the wheel speed values can be generated by wheel rotational rate sensors, or wheel speed sensors in general. They can be sent to a control unit of the type specified herein. The wheel speed sensors can be based on known sensor principles and detect, by way of example, an element that rotates with the wheel (e.g., a gearwheel or a disk with a profiled edge, the peaks or circumference of which is detected with an interval sensor). Advantageously, this sensor-based determination of the wheel speed values can be based on the values obtained by wheel speed sensors already present in a vehicle. These can be wheel speed sensors in particular that are also used for the functions of an ESC system (electronic stability control system) or an ABS system (anti-lock braking system).

A first and second wheel speed values can be compared with one another to determine whether the wheels are in the steering reference state.

In particular, one development of the present disclosure provides that the presence of steering reference state is determined when a difference between the first and second wheel speed values is less than a predetermined threshold value. This threshold value can be selected such that a deviation between the first and second wheel speed values is no more than 1% when the steering reference state is obtained.

Accordingly, such techniques simplify the process determining when this threshold has been exceeded, or to determine the difference in terms of control technology, such that it is possible to determine the steering reference state with low latencies.

According to some examples, if the reference state is obtained, an angle correction value (or offset value of the type specified above) can be determined on the basis of a current steering angle. In particular, the current steering angle, which can be measured by a steering angle measurement system in the vehicle, can be determined. This can then be compared with a previously stored reference angle, which corresponds, for example, to an expected or target zero setting steering angle. In particular, the difference between these can be obtained, and determined as the angle correction value. This angle correction value then be stored. It can then be used as the basis for future determinations of an actual steering angle set for the vehicle wheels, or in general as an actually implemented actual steering angle for the steering system. By way of example, a current steering angle measured by a steering angle measurement system can be calculated using the angle correction value. In particular, the (positive or negative) angle correction value can be added to this current steering angle to determine a set (actual) steering angle in relation to the determined zero setting, or the determined steering reference state.

Additionally or alternatively, the current steering angle can be stored as a reference steering angle when the steering reference state is obtained. The reference steering angle can correspond to a zero setting for the steering system, and/or it can define such a zero setting.

To increase the validity and precision of the results, the presence of the steering reference state is checked for plausibility on the basis of at least one state value (which is different than the wheel speed values) for the vehicle. This other state value is preferably the yaw rate. This value is usually known, or detected by the sensors normally installed in a vehicle. This type of plausibility check is simple and economical.

In principle, the method can be carried out by a control unit of the type specified below, in which this control unit can be an ESC (electronic stability control) control unit in particular. Accordingly, the wheel speed values can be obtained by the ESC control unit, which is configured to determine when the steering reference state has been obtained (on the basis thereof). As mentioned above, the first and second wheel speed values can each indicate a wheel rotational rate for a dedicated wheel, or be such a wheel rotational rate.

The present disclosure also relates to a control unit that is configured to execute a method according any of those aspects specified herein. The control unit can be digitally and/or electronically operated. It can comprise at least one processor and/or at least one memory. Program instructions can be stored in the memory, such that the control unit is able to carry out the method specified herein with the processor. In particular, the control unit can be connected to a communication bus (in particular a CAN bus). The control unit can communicate with the aforementioned wheel speed sensors and thus obtain the wheel speed values. The processor for the control unit can be configured to evaluate these wheel speed values in the manner specified herein, and to determine an angle correction value and/or steering reference angle of the type specified above. The control unit can also be connected to a steering angle measurement system in a steering system (e.g. via the communication bus). As specified above, the control unit can be an ESC control unit in the vehicle. This usually already has the aforementioned connections to the sensors or measurement system, such that it can be easily configured to execute any of the methods disclosed herein.

### BRIEF DESCRIPTION OF THE DRAWINGS

Exemplary embodiments of the present disclosure shall be explained below on the basis of the attached schematic drawings. Therein:

FIG. 1 shows a vehicle with a control unit according to a first exemplary embodiment of the present disclosure; and

FIG. 2 shows a flow chart for a method that is executed by the control unit in FIG. 1.

### DETAILED DESCRIPTION

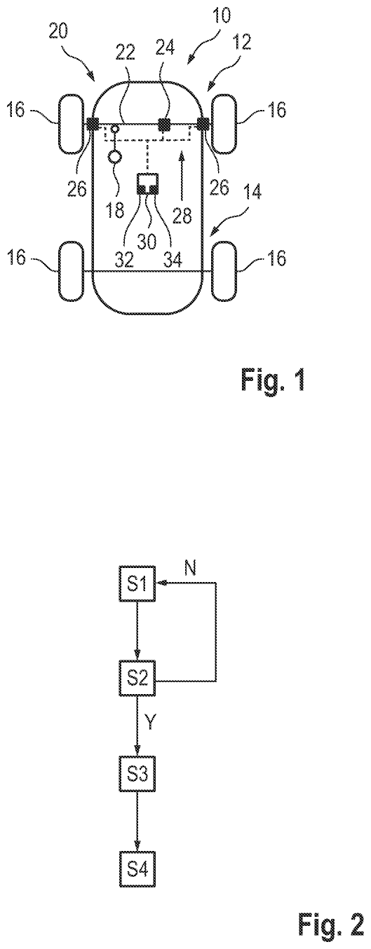

A vehicle 10 is shown in a simplified schematic top view in FIG. 1. A front axle 12 and rear axle 14 can be seen therein. Each axle 12, 14 has two wheels 16. These wheels 16 are on different sides of the vehicle on each axle, or at opposite ends of the respective axles 12, 14. There is also a steering element 18 in the form of a steering wheel. This is a component of the steering system 20. The steering system 20 comprises a highly schematically simplified steering gear 22. This can be designed according to the prior art, and comprise, e.g., a gear rack (not shown separately). A currently set steering angle of the steering system 20 can be determined with a steering angle measurement system 24. This can take place by determining a position of the gear rack in the manner known per se.

Wheel rotational rate sensors 26 are also shown on each of the wheels 16 on the front axle 12. In this example, only the front axle 12 can be steered, but not the rear axle 14.

The wheel rotational rate sensors 26 determine the wheel rotational rates in the form of the wheel speed values for each of the wheels 16 to which they are dedicated. The wheel rotational rate sensors 26 are connected to a communication bus 28, as is the steering angle measurement system 24 as well. A control unit 30 is also connected thereto, which is an ESC control unit in this example.

The ESC control unit obtains the wheel rotational rates from the two-wheel rotational rate sensors 26, as well as, preferably, a current steering angle measured by the steering angle measurement system 24.

The control unit 30 comprises a processor 32 and a memory 34. Information regarding an output, reference, or target steering angle can be stored in the memory 34, which corresponds to an assumed travel in a straight line by the vehicle 10. Due to the aforementioned asymmetry of the steering system 20 and any disruptions occurring when in operation (e.g., wear or deformation of individual links in the steering gear 22), the aforementioned target steering angle may not correspond to actual travel in a straight line by the vehicle 10.

The steering angle (reference steering angle) is therefore determined in the present case, when the vehicle is travelling in a straight line. The control unit 30 compares the wheel rotational rates obtained from the wheel rotational rate sensors 26 for this. If these rotational rates do not differ by more than a predetermined extent (i.e., the difference between them lies below a predetermined threshold value), it can be assumed that the vehicle is traveling in a straight line.

Other conditions can also be taken into account, such as concurrence over a longer period of time, or a minimum frequency of a corresponding concurrence that has been established.

A plausibility check of the aforementioned type can also be made. The plausibility check can also take a yaw rate into account, such that the frequency of the concurrence of the wheel rotational rates reaches a certain minimum value (in particular the absolute frequency), or should exhibit a certain relative relationship if there is not corresponding concurrence in comparison with other vehicle states (corresponding to a relative frequency of the preferably more frequently occurring state of the concurrence of the wheel rotational rates in relation to a significant difference therefrom).

This is based on the idea that the wheels 16 on the front axle 12 are on either the inside of the curve or the outside when travelling through a curve. These wheel rotational rates thus differ from one another when travelling through a curve (i.e., when not traveling in a straight line and/or during an active steering). When travelling in a straight line, these wheel rotational rates should be substantially the same. The plausibility check based on the aforementioned frequencies assumes that travel in a straight line is more frequent than travelling in a curve.

If the wheel rotational rates are determined to be the same by the control unit 30 or its processor 32, and, optionally, one of the aforementioned plausibility criteria are also satisfied, the current steering angle determined by the steering angle measurement system 24 can be stored as the reference steering angle in the memory 34. This corresponds to a zero setting for the steering system 20. Alternatively or additionally, the aforementioned angle correction value can be determined and stored as an offset value.

FIG. 2 shows the aforementioned method in the form of a flow chart. Wheel rotational rates are determined by the wheel rotational rate sensors 26, and output to the control unit 30 in step S1. The control unit then compares the wheel rotational rates in step S2. If these are not sufficiently the same (arrow N in FIG. 2), the method returns to step S1. If they are sufficiently equal (arrow Y in FIG. 2), the steering angle measured at that time by the steering angle measurement system 24 is set as the value for travel in a straight line. In particular, the aforementioned angle correction value is stored on the basis thereof.

The steering angle measurement system 24 measures another steering angle while the vehicle 10 is being operated in step S4. This is calculated using the angle correction value, in order to obtain an actual, effective, set steering angle, or a steering angle that is offset in relation to actual travel in a straight line.

### LIST OF REFERENCE SYMBOLS

10 vehicle

12 front axle

14 rear axle

16 wheel

18 steering wheel

20 steering system

22 steering gear

24 steering angle measurement system

26 wheel rotational rate sensor

28 communication bus

30 control unit

32 processor

34 memory

1-9. (canceled)

10. A method for determining a steering reference state for a vehicle, comprising:
obtaining, via a control unit, a first wheel speed value that is based on a wheel speed of a wheel on the vehicle;
obtaining, via the control unit, at least one second wheel speed value based on a second wheel speed for another wheel on the vehicle;
determining, via the control unit, whether a steering reference state exists that corresponds to travel in a straight line by the vehicle on the basis of the first and second wheel speed values; and
transmitting a control signal if the steering reference state is determined to exist.

11. The method of claim 10, wherein determining the steering reference state exists comprises determining that a difference between the first and second wheel speed values is less than a predetermined threshold value.

12. The method of claim 10, further comprising determining an angle correction value on the basis of a current steering angle when the steering reference state is determined.

13. The method of claim 10, further comprising storing a current steering as the reference steering angle when the steering reference state is determined.

14. The method of claim 10, further comprising processing the steering reference state to determine plausibility on the basis of at least one state value for the vehicle.

15. The method of claim 10, wherein the state value comprises a yaw rate

16. The method of claim 10, wherein the first and second wheel speed values each indicate a wheel rotational rate for each respective wheel assigned thereto.

17. A system for determining a steering reference state for a vehicle, comprising:
a first wheel sensor;
a second wheel sensor; and
a control unit, wherein the control unit is configured to obtain a first wheel speed value from the first wheel sensor that is based on a wheel speed of a wheel on the vehicle;
obtain a second wheel speed value from the second wheel sensor based on a second wheel speed for another wheel on the vehicle;
determine, whether a steering reference state exists that corresponds to travel in a straight line by the vehicle on the basis of the first and second wheel speed values; and
transmit a control signal if the steering reference state is determined to exist.

18. The system of claim 17, wherein the control unit is configured to determine the steering reference state exists by determining that a difference between the first and second wheel speed values is less than a predetermined threshold value.

19. The system of claim 17, wherein the control unit is configured to determine an angle correction value on the basis of a current steering angle when the steering reference state is determined.

20. The system of claim 17, wherein the control unit is configured to store a current steering as the reference steering angle when the steering reference state is determined.

21. The system of claim 17, wherein the control unit is configured to process the steering reference state to determine plausibility on the basis of at least one state value for the vehicle.

22. The system of claim 17, wherein the state value comprises a yaw rate

23. The system of claim 17, wherein the first and second wheel speed values each indicate a wheel rotational rate for each respective wheel assigned thereto.

24. A method for determining a steering reference state for a vehicle, comprising:
obtaining, via a control unit, a first wheel speed value that is based on a wheel speed of a wheel on the vehicle;
obtaining, via the control unit, at least one second wheel speed value based on a second wheel speed for another wheel on the vehicle;
determining, via the control unit, a steering reference state comprising a yaw rate that corresponds to travel in a straight line by the vehicle on the basis of the first and second wheel speed values; and
transmitting a control signal if the steering reference state is determined to exist.

25. The method of claim 24, wherein determining the steering reference state exists comprises determining that a difference between the first and second wheel speed values is less than a predetermined threshold value.

26. The method of claim 24, further comprising determining an angle correction value on the basis of a current steering angle when the steering reference state is determined.

27. The method of claim 24, further comprising storing a current steering as the reference steering angle when the steering reference state is determined.

28. The method of claim 24, further comprising processing the steering reference state to determine plausibility on the basis of at least one state value for the vehicle.

29. The method of claim 24, wherein the first and second wheel speed values each indicate a wheel rotational rate for each respective wheel assigned thereto.
